(19) United States
(12) Patent Application Publication
(10) Pub. No.: US 2005/0255884 A1
(43) Pub. Date: Nov. 17, 2005

(54) Method and apparatus for wireless transmission adaptation

(76) Inventors: Yun-Ning Shih, Pan Chiao City (TW); Yun-Min Wang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/842,567

(22) Filed: May 11, 2004

(51) Int. Cl. H04M 1/00

(52) U.S. Cl. 455/557

(57) ABSTRACT

A wireless transmission adaptation method and apparatus for converting a wireless signal between a first and second electrical devices are described. The apparatus has a first wireless transmission interface, a second wireless transmission interface and a control unit. The first wireless transmission interface is used for compatibility with a first wireless signal from the first electrical device. The second wireless transmission interface is used for compatibility with a second wireless signal from the second electrical device. The control unit is electrically coupled between the first and second wireless transmission interfaces. The control unit provides the format conversion for the signals transmitted between the first and second wireless transmission interfaces.

### BACKGROUND OF THE INVENTION

1. Field of the Invention

The invention refers to a method and apparatus for wireless transmission adaptation, more particularly to a method and apparatus for the wireless transmission adaptation between heterogeneous wireless signals.

2. Description of the Prior Art

Each of the technologies widely used in wireless network transmission, such as Bluethooth, HomeRF, IEEE802.11 and so on, has its respective merits and drawbacks, and its respective market demand. However, using radio wave as transmission medium offers a great advantage, that is, this type of signal transmission is non-directional. In other words, the wireless unit at a receiving end can have any orientation relative to the position of that unit at a transmitting end. Signals can be transmitted between receiving and transmitting ends through radio waves, as long as they do not go beyond the range of the receiving distance. On the other hand, radio waves also offer another property, i.e., the transmission carried out via radio wave is difficult to block or break by obstruction.

Although the above advantages are obtained from radio wave transmission, there is a critical disadvantage of wireless transmission, i.e., radio wave tends to suffer from interference from external signals during propagation, resulting in the distortion and attenuation of signals. In order to extend transmission distance, the power consumption of the system has to be increased correspondingly; thus the difficulty of chip design for radio wave aspect is higher. Additionally, due to the complexity of channel and frequency-locking modes, this technology is prohibitively expensive.

In addition to the above radio wave transmission, wireless transmission can use optical transmission techniques, such as infrared ray (IR). Compared with radio wave transmission, infrared transmission offers good noise interference-resistance, and is relatively cheap. Currently, infrared ray also is one of the techniques preferably used for short-distance wireless transmission. However, the inclusion angle of transmission for infrared ray is still a limitation, and infrared transmission is susceptible to blocking by obstruction; it can thus only be performed when directly facing the receiving end.

Therefore, these two wireless transmission techniques of radio wave and infrared ray have been described along with their respective merits and drawbacks. Accordingly, it is desirable to integrate their respective merits into one single wireless signal conversion platform; such integration would expand the application level and market of wireless transmission.

### SUMMARY OF THE INVENTION

One main object of the invention is to provide a method and apparatus for wireless transmission adaptation that enables communication between heterogeneous wireless signals.

Another object of the invention is to provide a method and apparatus for wireless transmission adaptation that avoids the spatial obstacle influence of the environment to provide an effective and low-interference wireless signal transmission.

In order to achieve the above objects, the present invention provides an apparatus for wireless transmission adaptation, which is used to convert the wireless signal between a first electrical device and a second electrical device, and is described as follows. A first wireless transmission interface is adapted to be compatible with a first wireless signal from the first electrical device. A second wireless transmission interface is adapted to be compatible with a second wireless signal from the second electrical device. A control unit is electrically coupled between the first wireless transmission interface and the second wireless transmission interface. The control unit provides the format conversion for the signals transmitted between the first wireless transmission interface and the second wireless transmission interface.

In order to achieve the above object, the present invention further provides a method for wireless transmission adaptation, which is used to convert the wireless signal between a first electrical device and a second electrical-device, and is described as follows. A first wireless transmission interface receives a first wireless signal transmitted from the first electrical device. The first wireless signal is converted into a second wireless signal compatible with the second wireless unit. A second wireless transmission interface transmits the second wireless signal to the second unit.

In order to achieve the above objects, the present invention provides a wireless network communication system, which is described as follows. A first electrical device transmits a first wireless signal. A first wireless transmission adapter, wirelessly receives the first wireless signals transmitted from the electrical device, and converts the first wireless signals into a second wireless signals. A second wireless transmission adapter, wirelessly receives the second wireless signals transmitted from the first transmission adapter, and converts the second wireless signals into the first wireless signals. A second electrical device wirelessly receives the first wireless signals transmitted from the second transmission adapter.

With reference to the accompanying drawings, the features and technical contents of the present invention will become apparent from the detailed description of the present invention; however, the accompanying drawings are merely provided for reference and illustrative purpose, and are not intended to limit the scope of the invention.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a diagram illustrating signal transmission provided by a wireless transmission adapter according to this invention;

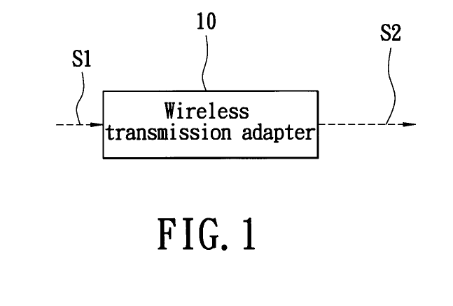

FIG. 2 is a circuit block diagram illustrating a wireless transmission adapter according to this invention;

FIG. 3 is a flowchart of signal conversion and delivery of a wireless transmission adapter according to this invention;

FIG. 4 is a structural diagram of a wireless network communication system comprising the wireless transmission adapter according to this invention and electrical devices;

FIG. 5 is a structural diagram of another wireless network communication system comprising the wireless transmission adapter according to this invention and electrical devices; and

FIG. 6 is a diagram of 3-dimensional space.

### DETAILED DESCRIPTION OF THE EMBODIMENTS

At present, there are no intercommunicating approaches between various wireless transmission techniques employing respective heterogeneous energy carriers. The respective heterogeneous energy carriers may be covered between optical waves with strong particle-like property to radio waves, acoustic waves with strong wave-like property or heterogeneous energy carriers of the radio wave at differing frequencies. In order to overcome the above disadvantages, the present invention provides a wireless transmission adapter 10. The wireless transmission adapter 10 is a signal conversion platform for transmission between various wireless communication techniques employing heterogeneous energy carriers, and used to receive and internally process a first wireless signal S1, so as to transmit it as a second wireless signal S2. The first and second wireless signals mentioned here use different energy carriers.

Furthermore, the previously mentioned optical waves of strong particle-like property may be an infrared ray, ultraviolet ray, visible light, laser light, Y-ray or X-ray. The radio waves of strong wave-like property may be radio frequency (RF), the common wireless LAN network transmission techniques, such as Bluethooth, IEEE802.11, HomeRF, etc., that use radio frequency as a transmission medium. In the following, for expository convenience, the description will be given for the wireless transmission between heterogeneous energy carriers by means of respective examples of infrared and radio frequency, but as it is used in the present invention, the heterogeneous energy carriers is not intended to be limited hereto.

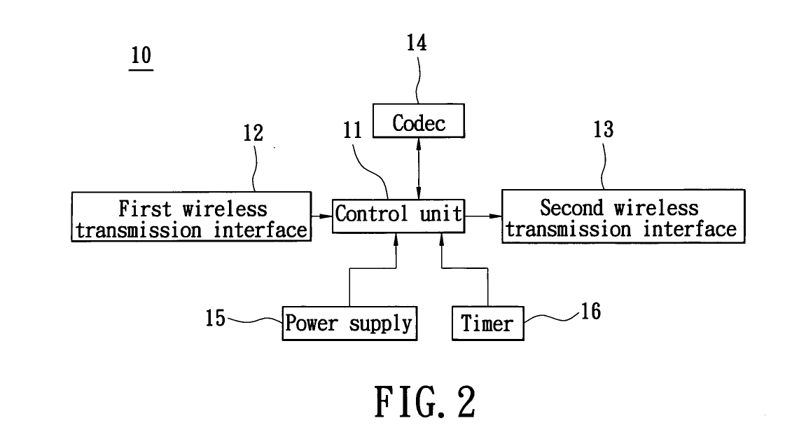

With reference to FIG. 2, it illustrates a circuit block diagram of the wireless transmission adapter according to the present invention. The wireless transmission adapter 10 comprises a control unit 11, a first wireless transmission interface 12, a second wireless transmission interface 13, a codec 14, power supply 15 and timer 16.

The first wireless transmission interface 12 is used to deliver information from or to an external electrical device via, for example, infrared signals. The first wireless transmission interface 12 is, for example, an infrared receiver or infrared transmitter, depending on which transmission direction is desired, or includes both of the same. As illustrated in FIG. 2, the first wireless transmission interface 12 is an infrared receiver used at the receiving end for the signals.

The second wireless transmission interface 13 is used to deliver information from or to another external electrical device via, for example, radio signals. Similarly, the second wireless transmission interface 13 is, for example, a radio receiver or radio transmitter, depending on which transmission direction is desired, or includes both of the same. As illustrated in FIG. 2, the second wireless transmission interface 13 is a radio transmitter used at the transmitting end for the signals.

And the control unit 11 is electrically coupled between the first and second wireless transmission interfaces 12 and 13. As it is known, the delivery of infrared signals and radio signals is implemented respectively by following their respective transport protocols and formats of their own specifications. Therefore, the control unit 11 acts as a bridge of transmission, enabling the transmission to be achieved by signal format conversion between the first and second wireless transmission interfaces 11 and 13. For example, infrared signals are converted into the format in which radio signals are transmitted, or radio signals are converted into the format in which infrared signals are transmitted. During signal format conversion, the control unit 11 is needed to provide format conversion for the modulated and demodulated information on the information contained in the transmitted signals. This processing is handled by the codec 14 electrically coupled to the control unit 11. Alternatively, the control unit 11 and codec 14 are integrated into a single IC circuit.

In order to extend the standby time of the wireless transmission adapter and reduce the power consumption of the power supply 15 electrically coupled to the control unit 11, the present invention is specially provided with a timer 16 electrically coupled to the control unit 11. The purpose of the timer 16 is that when no wireless signal is received by the wireless transmission adapter 10, the timer is activated to count until a predetermined time. For example, if the wireless transmission adapter 10 does not receive any external wireless signal within a predetermined time, then the control unit 11 will automatically enter into the sleep mode for power conservation, thus reducing the power consumption of the power supply 15. In addition, the wireless transmission adapter 10 automatically wakes up when an external wireless signal is received again, and returns to the normal working mode.

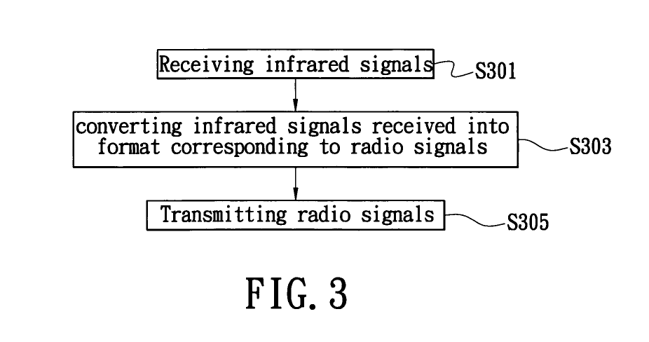

With reference to FIG. 3, the adaptation flow of the wireless signals implemented by the wireless transmission adapter 10 is described. In this case, the wireless transmission adapter 10 provides the format conversion from infrared signals to radio signals. Initially, when an external electrical device is pointed towards the first wireless transmission interface 12 of the wireless transmission adapter to transmit infrared signals with the carried information, the first wireless transmission interface 12 of the wireless transmission adapter 10 receives the infrared signals from the device (S301). The control unit 11 then instructs the codec 14 to convert the received infrared signals into the format corresponding to radio signals (S303). After the signal format conversion in the previous step, the control unit 11 then transmits the resulting radio signals to an exterior electrical device, which is capable of receiving the signals (S305).

In FIG. 3, a preferred implementation of unidirectional transfer between different types of signals is illustrated. However, the operation mechanism disclosed in the wireless transmission adapter 10 is not intended to be limited hereto, and other implementations and variants are possible. For example, it is possible to provide bi-directional wireless signal conversion, or one of the previously mentioned infrared signals and radio signals may be replaced with that of acoustic wave transmission. In the same way, other modifications can be made according to the above description. Obviously, those of ordinary skill in the art can easily conceive this.

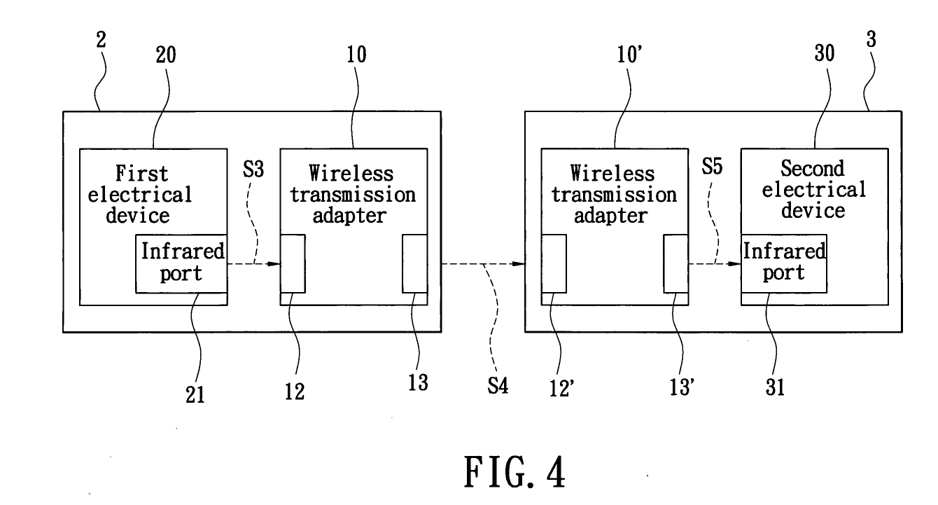

As described above, the wireless transmission adapter 10 can substantially provide a wireless signal conversion platform for transmission between different wireless signals (heterogeneous energy carriers). With the use of the features of the wireless transmission adapter 10, in actual application a variety of the electrical devices with wireless transmission capability are integrated together to form a wireless network communication system. With reference to FIG. 4, a wireless network communication system provided with the wireless transmission adapter according to this invention is illustrated.

In FIG. 4, two closed indoor spaces 2 and 3 are illustrated. Indoor space 2 contains a first electrical device 20 and a wireless transmission adapter 10, and the indoor space 3 contains a second electrical device 30 and a wireless transmission adapter 10′. The first and second electrical devices 20 and 30 include respective infrared ports 21 and 31 that can receive and transmit wireless signals, respectively. The first electrical devices 20 acts as transmitting end to transmit infrared signals S3 from the infrared port 21, and the second electrical device 30 acts as receiving end to receive infrared signals S5 from the infrared port 31. Furthermore, the internal constitution of the wireless transmission adapter 10 is illustrated in FIG. 2. The internal constitution of the wireless transmission adapter 10′ is similar to that illustrated in FIG. 2, except that the first wireless transmission interface 12 serving as the receiving end in FIG. 2 is replaced with the first wireless transmission interface 13′ as the transmitting end in this figure, and the second wireless transmission interface 13 serving as the transmitting end in FIG. 2 is replaced with the second wireless transmission interface 12 as the receiving end in this figure. The other components are the same.

Therefore, in FIG. 4, the process of wireless signal delivery between the first and second electrical devices 20 and 30 is described as follows. For the indoor space 2, the infrared signals S3 transmitted from the infrared port 21 of the first electrical device 20 are received by the first wireless transmission interface 12 of the wireless transmission adapter 10. The received infrared signals S3 are then processed for format conversion by the wireless transmission adapter 10. Radio signals S4 are then transmitted by the second wireless transmission interface 13. In another indoor space 3, the second wireless transmission interface 12′ of the wireless transmission adapter 10′ can receive the radio signals S4, and then the received radio signals S4 are processed for format conversion by the wireless transmission adapter 10′. Afterwards, the first wireless transmission interface 13′ transmits infrared signals S5; thus the second electrical device 30 receives at its infrared port 31 the infrared signals S5 transmitted by the wireless transmission apparatus 10′.

In conventional techniques, it is impossible to implement the transmission by infrared ray between two closes indoor spaces, because the infrared signals cannot pass through the wall. In comparison, the wireless transmission adapter 10 and 10′ according to this invention change a partial transmission path by replacing an infrared ray with a radio wave, thus enabling the transmission to pass through obstructions such as the wall and overcome any obstacles in transmission path. The first electrical device 20 in FIG. 4 can be conceived of as an infrared remote control and the second electrical device 30 can be conceived of as, for example, a wireless household appliances or another electrical device.

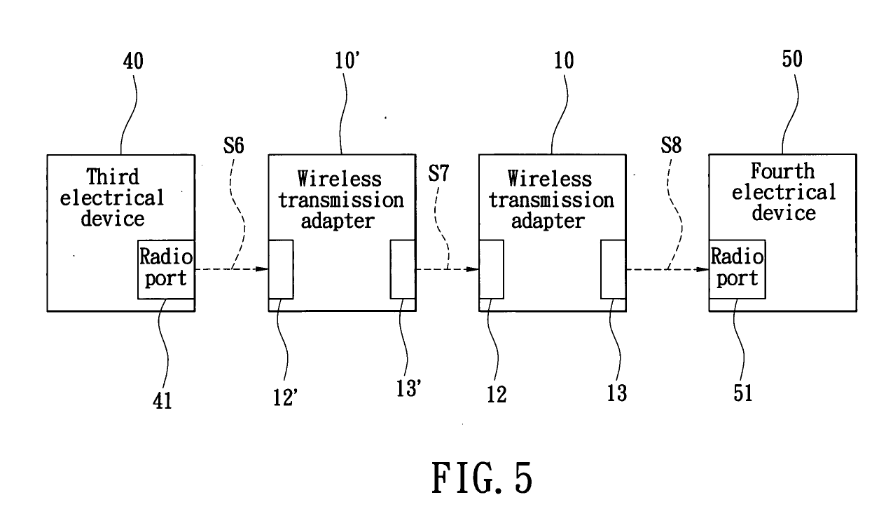

As described with respect to FIG. 4, one embodiment of this invention has been provided for overcoming the obstacles in transmission path. In FIG. 5, another embodiment of this invention is provided for overcoming the obstacles in transmission path. The third and fourth electrical devices 40 and 50 in FIG. 5 are located inside the same space. The third and fourth electrical devices 40 and 50 are provided with their radio ports 41 and 51, which are capable of transmitting and receiving radio signals, respectively. Since the delivery of radio signal is susceptible to external interference, in the situation where the transmission needs to pass through an interference area, infrared signals S7 of the wireless transmission adapters 10′ and 10 are used.

In this case, the radio signals S6 transmitted from the radio port 41 of the third electrical device 40 are received by the second wireless transmission interface 12′ of the wireless transmission adapter 10′, and then the first wireless transmission interface 13′ of the wireless transmission adapter 10′ transmits the corresponding infrared signals S7. On the other hand, the infrared signals S7 are received by the first wireless transmission interface 12 of the wireless transmission adapter 10, and then the second wireless transmission interface 13 transmits the corresponding radio signals S8; eventually, the radio signals S8 are received by the radio port 51 of the fourth electrical device 50. Although the third and fourth electrical devices 40 and 50 in FIG. 5 are sending information via radio wave, in virtue of the wireless transmission adapters 10 and 10′, the portion of the transmitting path between the third and fourth electrical devices, which is susceptible to interference, is changed to use infrared signal, thus guaranteeing that the signal delivery between the third and fourth electrical devices 40 and 50 can avoid interference from external noise.

In FIGS. 4 and 5, the wireless transmission adapters 10 and 10′ can be conceived of as one level of wireless signal adapters. If wireless signals need to be sent remotely, this can be achieved by cascading multiple adapters, one level by one level.

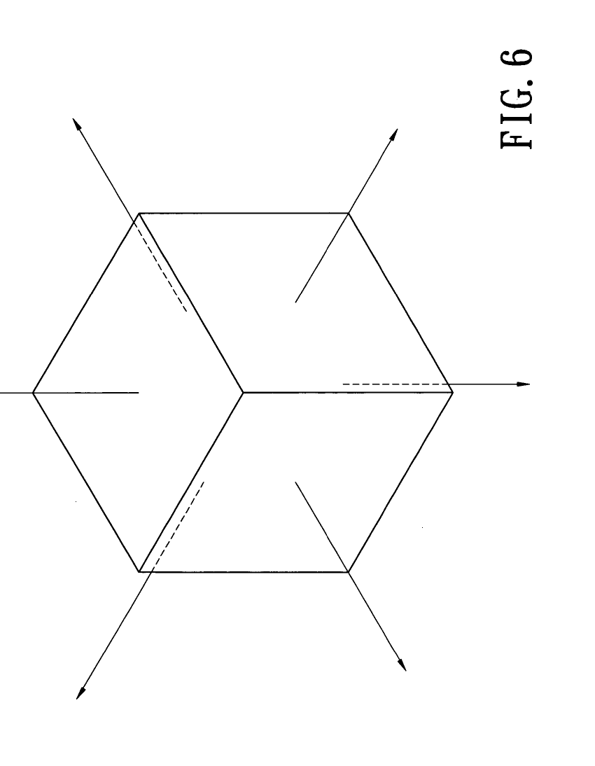

With reference to FIG. 6, one cube in 3 dimensions has six surfaces, and each surface of the cube can be considered as one transmission direction. The previously mentioned indoor space can be conceived of as a cube. When the wireless transmission adapter 10 according to this invention is used in the indoor space, the adapter 10 can be arranged on the inner and exterior sides of each surface of the indoor space, such that the inner and exterior wireless transmission adapters 10 of each surface can deliver information via radio wave, thus overcoming the obstacles in the transmission path. Therefore, the electrical devices inside the indoor space can extend their transmission paths in different direction via the wireless transmission adapters 10 during wireless signal delivery to the exterior. Since the wireless transmission adapters 10 at inner and exterior sides are very close to each other, there is no interference among the respective wireless transmission adapters of these surfaces, which operate at low power level, even if they use the same transmitting frequency.

Additionally, with respect to the wireless LAN network in current office environment, the master and slave relationship of the computers is determined based on their node position in the network. When the wireless transmission adapter according to this invention is applied to wireless LAN network, unidirectional and bidirectional wireless transmission can be provided; different possible mater and slave relationships can be determined depending on the position from which signals are transmitted, thus providing a wireless LAN network in which the priorities of the master and slave nodes are variable.

Therefore, the following advantages can be achieved by using the method and apparatus for wireless transmission adaptation according to the invention:

1. The transmission can be carried out in multiple wireless transmission modes with more than one type of carrier depending on the actual environment.

2. There are many advantages, including low cost, low interference, stable production quality and ease of assembly.

With reference to the drawings, the description has been given above merely for one of preferred embodiment of this invention; those skilled in the art will appreciate numerous modifications and variations therefrom. It is intended that the appended claims cover all such modifications and variations as fall within the spirit and scope of this present invention.

1. A wireless transmission adapter for converting a wireless signal between a first and second electrical devices, comprising:
a first wireless transmission interface used for compatibility with a first wireless signal from the first electrical device;
a second wireless transmission interface used for compatibility with a second wireless signal from the second electrical device; and
a control unit, electrically coupled between the first and second wireless transmission interfaces, wherein the control unit provides format conversion for the signals transmitted between the first and second wireless transmission interfaces.

2. The wireless transmission adapter according to claim 1, wherein the first and second wireless signals use heterogeneous energy carriers for transmission.

3. The wireless transmission adapter according to claim 2, wherein the heterogeneous energy carriers are two of an optical wave with a strong particle-like property, a radio wave and an acoustic wave with a strong wave-like property.

4. The wireless transmission adapter according to claim 3, wherein the optical wave with strong particle-like property is an infrared ray, an ultraviolet ray, visible light, laser light, a Y-ray or an X-ray.

5. The wireless transmission adapter according to claim 3, wherein the radio wave with strong wave-like property is radio frequency (RF).

6. The wireless transmission adapter according to claim 2, wherein the heterogeneous energy carriers are different frequencies of radio waves.

7. The wireless transmission adapter according to claim 1, further comprising a codec for providing modulation and demodulation during formation conversion for signal transmitted between the first and second wireless transmission interfaces.

8. The wireless transmission adapter according to claim 1, further comprising a timer for enabling the wireless transmission adapter to enter a sleep mode for power conservation.

9. A method for wireless transmission adaptation for converting a wireless signal between a first and second electrical devices, comprising the steps of:
receiving a first wireless signal transmitted from the first electrical device by a first wireless transmission interface;
converting the first wireless signal to be compatible with a second wireless signal from the second electrical device; and
sending the second wireless signal to the second electrical device by a second wireless transmission interface.

10. The method for wireless transmission adaptation according to claim 9, wherein the first and second wireless signals use heterogeneous energy carriers for transmission.

11. The method for wireless transmission adaptation according to claim 10, wherein the heterogeneous energy carriers are two of an optical wave with a strong particle-like property, a radio wave and an acoustic wave with a strong wave-like property.

12. The method for wireless transmission adaptation according to claim 11, wherein the optical wave with a strong particle-like property is an infrared ray, an ultraviolet ray, visible light, laser light, a Y-ray or an X-ray.

13. The method for wireless transmission adaptation according to claim 11, wherein the radio wave with a strong wave-like property is radio frequency (RF).

14. The method for wireless transmission adaptation according to claim 10, wherein the heterogeneous energy carriers are different frequencies of radio waves.

15. A wireless network communication system, comprising:
a first electrical device for transmitting a first wireless signal;
a first wireless transmission adapter, for wirelessly receiving the first wireless signals transmitted from the electrical device, and converting the first wireless signals into a second wireless signals;
a second wireless transmission adapter, for wirelessly receiving the second wireless signals transmitted from the first transmission adapter, and converting the second wireless signals into the first wireless signals; and
a second electrical device, for wirelessly receiving the first wireless signals transmitted from the second transmission adapter.

16. The wireless network communication system according to claim 15, wherein the first and second wireless signals use heterogeneous energy carriers for transmission.

17. The wireless network communication system according to claim 16, wherein the heterogeneous energy carriers are two of an optical wave with a strong particle-like property, a radio wave and an acoustic wave with a strong wave-like property.

18. The wireless network communication system according to claim 17, wherein the optical wave with a strong particle-like property is an infrared ray, an ultraviolet ray, visible light, laser light, a Y-ray or an X-ray.

19. The wireless network communication system according to claim 17, wherein the radio wave with a strong wave-like property is radio frequency (RF).

20. The wireless network communication system according to claim 16, wherein the heterogeneous energy carriers are different frequencies of radio waves.

21. The wireless network communication system according to claim 15, wherein the first and second wireless transmission adapters comprise:
a first wireless transmission interface compatible with the first wireless signal;
a second wireless transmission interface compatible with the second wireless signal; and
a control unit, electrically coupled between the first and second wireless transmission interfaces, wherein the control unit provides format conversion for the signals transmitted between the first and second wireless transmission interfaces.

22. The wireless network communication system according to claim 21, further comprising a codec for providing modulation and demodulation during formation conversion for signal transmitted between the first and second wireless transmission interfaces.

23. The wireless network communication system according to claim 21, further comprising a timer for enabling the wireless transmission adapter to enter a sleep mode for power conservation.
